(19) United States
(12) Patent Application Publication
(10) Pub. No.: US 2011/0119004 A1
(43) Pub. Date: May 19, 2011

(54) Method and a Device for Measuring and Calculating the Insulation Resistance of a High Voltage Power Management System in a Hybrid Power Vehicle

(75) Inventor: Bing Liu, Wuhu (CN)

(73) Assignee: Chery Automobile Co., Ltd., Wuhu (CN)

(21) Appl. No.: 13/002,964

(22) PCT Filed: Jul. 7, 2009
(86) PCT No.: PCT/CN2009/072663

§ 371 Date: Jan. 6, 2011

(30) Foreign Application Priority Data
Jul. 8, 2008 (CN) 200810133074

(51) Int. Cl. G06F 19/00

(52) U.S. Cl. 702/63

(57) ABSTRACT

This invention provides a method and a device for measuring and calculating the insulation resistance of a high voltage power management system in a hybrid power vehicle, which are designed to effectively measure the insulation resistance; said method and device for measuring the insulation resistance of a high voltage power management system in a hybrid power vehicle comprising a central process unit circuit, a battery-voltage-balance detection unit and an insulation resistance detection unit. The voltage signal outputted by the battery-voltage-balance detection unit is assessed by the central process unit circuit; the insulation-resistance detection unit is controlled by the central process unit circuit to start up when voltage is slightly out of balance, the signal detected by the insulation resistance detection unit is transmitted to the central process unit circuit, and the signal is transmitted to the battery management system by the central process unit circuit via CAN bus. The present invention not only is capable of measuring the total voltage of the battery with high precision and monitoring the real-time insulation state, but also is capable of effectively measuring the insulation resistance.

### FIELD OF THE INVENTION

The present invention relates to a method and device for measuring and calculating the insulation resistance of the high voltage power management system in a hybrid power vehicle.

### DESCRIPTION OF THE PRIOR ART

As manned transportation means, the safety of vehicles is always of top concerns for people. For hybrid power vehicles or pure electric vehicles, the safety of high voltage battery is particularly important, and the insulation detection device of the high voltage battery system is the first step to guarantee the safety of the vehicle as a whole. At present, the available devices mostly are monitoring devices that are merely capable of monitoring the insulation state, but still fail to measure the value of the insulation resistance. In addition, due to their insufficient accuracy for battery voltage measurement, such monitoring devices cannot substitute the battery voltage acquisition unit in the battery management system, which leads to repeated and complicated configuration and increased volume and cost. What's more, most of the designs of such monitoring devices do not have isolation means, causing unstable factor.

### SUMMARY OF THE INVENTION

The object of the present invention is to provide a method and a device for measuring and calculating the insulation resistance of the high voltage power management system in a hybrid power vehicle, such a method and device is capable of measuring and calculating the insulation resistance effectively.

The present invention provides two technical solutions based on the same inventive concept:

The first technical solution is to provide a method for measuring and calculating the insulation resistance of a high voltage power management system in a hybrid power vehicle. This method involves using a central process unit circuit, a battery-voltage-balance detection unit and a insulation resistance detection unit. The voltage signal outputted by the battery-voltage-balance detection unit is assessed by the central process unit circuit. When the battery voltage is out of balance slightly, the insulation resistance detection unit insulation resistance is activated under the control of the central process unit circuit. The detection signal from the insulation resistance detection unit is transmitted to the central process unit circuit, and is then transmitted to the battery management system by the central process unit circuit via CAN bus.

Another technical solution of the present invention is to provide a device for measuring and calculating the insulation resistance of a high voltage power management system in a hybrid power vehicle, which is used to achieve said method. Such a device comprises a central process unit circuit, a battery-voltage-balance detection unit and a insulation resistance detection unit, wherein, the control ends of the battery-voltage-balance detection unit and the insulation resistance detection unit are connected with the signal output end of the central process unit circuit, and the detection signal output ends of the battery-voltage-balance detection unit and the insulation resistance detection unit are connected with the signal input end of the central process unit circuit.

The beneficial effects of the present invention are:

The present invention not only is capable of measuring and calculating the total voltage of the battery with high precision and monitoring the insulation state in real-time, but also is capable of effectively measuring the insulation resistance.

### BRIEF DESCRIPTION OF THE DRAWINGS

FIG. 1 is the schematic circuit diagram of the battery high voltage system;

FIG. 2 is the schematic circuit diagram of the central process unit circuit;

FIG. 3 is the schematic circuit diagram of the battery-voltage-balance detection unit;

FIG. 4 is the schematic circuit diagram of the insulation resistance detection unit.

### DETAILED DESCRIPTION OF THE PREFERRED EMBODIMENTS

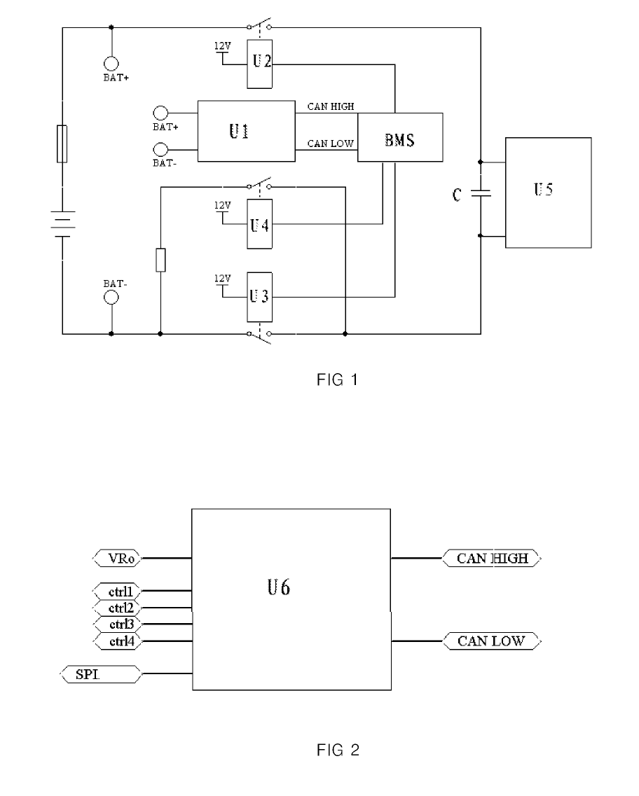

As shown in FIG. 1, the battery high voltage system comprises a battery management system BMS, an anode relay U2, an cathode relay U3, a pre-charge relay U4, a pre-charge capacitor C, an inverter U5 and a device U1 for measuring and calculating the insulation resistance, wherein, all the components except the device U1 for measuring and calculating the insulation resistance, fall within the prior art.

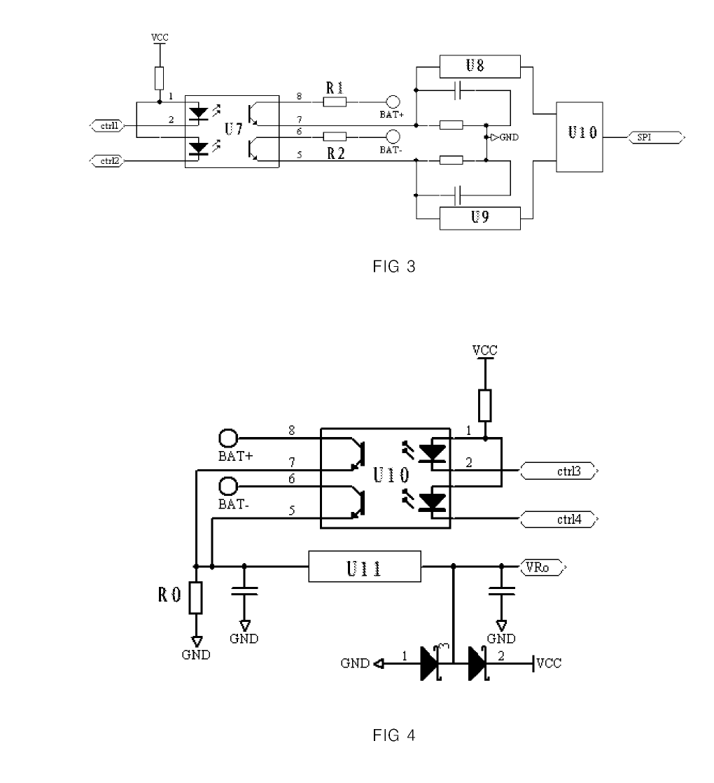

As shown in FIG. 2, FIG. 3 and FIG. 4, the device for measuring and calculating the insulation resistance comprises a central process unit circuit, a battery-voltage-balance detection unit circuit and a insulation resistance detection unit circuit, wherein the control ends of the battery-voltage-balance detection unit circuit and the insulation resistance detection unit circuit are connected with the signal output end of the central process unit circuit, and the detection signal output ends of the battery-voltage-balance detection unit circuit and the insulation resistance detection unit circuit are connected with the signal input end of the central process unit circuit.

As shown in FIG. 2, a Singlechip U6 is used as the central process unit circuit.

As shown in FIG. 3, the circuit structure of the battery-voltage-balance detection unit is described as follows: the optical relay U7 is connected with the anode BAT+ and the cathode BAT− of the battery via the voltage divider resistors R1 and R2 respectively; the control ends ctrl1 and ctrl2 of the optical relay are connected with the Singlechip; the signal output ends of the optical relay are connected with the operational amplifiers U8 and U9; the operational amplifiers are connected with the A/D conversion integrated circuit U10, and the signal output end SPI of the A/D conversion integrated circuit is connected with the signal input end of the Singlechip.

As shown in FIG. 4, the circuit structure of the insulation resistance detection unit is as follows: the optical relay U10 is connected with the insulation measurement resistor R0; the control ends ctrl3 and ctrl4 of the optical relay are connected with the Singlechip; the signal output end of the optical relay is connected with the operational amplifier U11, and the signal output end VR0 of the operational amplifier is connected with the signal input end of the Singlechip.

The voltage signal outputted from the battery-voltage-balance detection unit is assessed by the Singlechip U6; when the battery voltage is slightly out of balance, ctrl3 or ctrl4 are of low voltage level under the control of Singlechip, and insulation resistance detection unit is activated; the signal VR0 detected by the insulation resistance detection unit is transmitted to the Singlechip, and it is further transmitted to the battery management system BMS by the Singlechip via CAN bus.

When the voltage is seriously out of balance, the Singlechip disconnects the insulation resistance detection unit and simultaneously sends high level alert signal to the battery management system BMS via CAN bus, and consequently the battery management system BMS controls to disconnect the battery high voltage system.

When the battery voltage is in balance, the Singlechip instructs the insulation resistance detection unit to remain stand-by state and simultaneously sends fault-free signal to the battery management system via CAN bus. At this moment, the control ends ctrl1 and ctrl2 of the optical relay are of low voltage level.

While measuring and calculating the resistance, if BAT+>BAT−, the Singlechip controls the ctrl3 to be of low voltage level, and it measures the insulation resistance of the BAT+ end. The calculation formula for the insulation resistance is R=R0*[BAT+−VR0]/VR0*[1+(BAT−/BAT+)] (wherein R refers to the insulation resistance, R0 refers to the insulation measurement resistance, and VR0 refers to the voltage of the insulation measurement resistor).

If BAT−>BAT+, the Singlechip controls ctrl4 to be of low voltage level and measures the insulation resistance of BAT− end. The calculation formula for insulation resistance is R=R0*[BAT−−VR0]/VR0*[1+(BAT+/BAT−)].

For the insulation resistance state, moderate alert point is 1000Ω/V, high alert point is 100Ω/V, the detection formula is R0/VR0. In this embodiment, the range of moderate alert with the voltage balance method is 100Ω/V˜1000Ω/V, so the value of the insulation measurement resistance ranges between 400Ω˜500Ω.

Finally, it must be mentioned that: The above description and embodiments are merely used to describe rather than limit the present invention. Although the detailed description of the present invention is provided with reference to preferred embodiments, those skilled in the art should understand that all the modifications or equitable substitutions to the present invention without deviation from the spirit and conception of present invention shall be covered by the claims of present invention.

1. A method for measuring and calculating the insulation resistance of a high voltage power management system in a hybrid power vehicle, characterized in the following:
said method involves using a central process unit circuit, a battery-voltage-balance detection unit and an insulation resistance detection unit, wherein,
the voltage signal outputted by the battery-voltage-balance detection unit is assessed by the central process unit circuit;
when the battery voltage is slightly out of balance, insulation resistance detection unit is activated under the control of the central process unit; the signal detected by the insulation resistance detection unit is transmitted to the central process unit and is further transmitted to the battery management system BMS by the central process unit via CAN bus.

2. The method for and calculating measuring the insulation resistance of a high voltage power management system in a hybrid power vehicle of claim 1, characterized in: when voltage is seriously out of balance, the central process unit disconnects the insulation resistance detection unit and simultaneously sends high level alert signal to the battery management system BMS via CAN bus, and consequently the battery management system BMS controls to disconnect the battery high voltage system.

3. The method for measuring and calculating the insulation resistance of a high voltage power management system in a hybrid power vehicle of claim 1, characterized in: when the battery voltage is in balance, the central process unit instructs the insulation resistance detection unit to remain stand-by state and simultaneously sends fault-free signal to the battery management system via CAN bus.

4. A device for measuring and calculating the insulation resistance of a high voltage power management system in a hybrid power vehicle, which is used to achieve the method of claim 1, said device being characterized in: it comprises a central process unit circuit, a battery-voltage-balance detection unit and an insulation resistance detection unit, wherein the control ends of the battery-voltage-balance detection unit and the insulation resistance detection unit are connected with the signal output end of the central process unit circuit, and the detection signal output ends of the battery-voltage-balance detection unit and the insulation resistance detection unit are connected with the signal input end of the central process unit circuit.

5. The device for measuring and calculating the insulation resistance of a high voltage power management system in a hybrid power vehicle of claim 4, characterized in that a Singlechip is used as the central process unit circuit.

6. The device for measuring and calculating the insulation resistance of a high voltage power management system in a hybrid power vehicle of claim 5, characterized in that the circuit structure of the battery-voltage-balance detection unit is as follows: the optical relay is connected with the anode and the cathode of the battery via the divider resistors; the control end of the optical relay is connected with the Singlechip; the signal output end of the optical relays are connected with the operational amplifiers, and the operational amplifiers are connected with the A/D conversion integrated circuit, and the signal output end of the A/D conversion integrated circuit is connected with the signal input end of Singlechip.

7. The device for measuring and calculating the insulation resistance of a high voltage power management system in a hybrid power vehicle of claim 6, characterized in that the circuit structure of the insulation resistance detection unit is as follows: the optical relay is connected with the insulation measurement resistor, the control ends of optical relay are connected with the Singlechip, the signal output end of the optical relay is connected with the operational amplifier, and the signal output end of the operational amplifier is connected with the signal input end of Singlechip.

8. The method for measuring and calculating the insulation resistance of a high voltage power management system in a hybrid power vehicle of claim 2, characterized in: when the battery voltage is in balance, the central process unit instructs the insulation resistance detection unit to remain stand-by state and simultaneously sends fault-free signal to the battery management system via CAN bus.
